(19) United States
(12) Patent Application Publication
(10) Pub. No.: US 2026/0326000 A1
(43) Pub. Date: Oct. 22, 2026

(54) VaporWeave

(71) Applicant: Christopher Neil Quiggle-Boyer, Seaside, OR (US)

(72) Inventor: Christopher Neil Quiggle-Boyer, Seaside, OR (US)

(73) Assignee: David Neil Boyer, Eugene, OR (US)

(21) Appl. No.: 19/545,015

(22) Filed: Feb. 20, 2026

(51) Int. Cl. B01D 39/14; B01D 46/00

(52) U.S. Cl. CPC B01D 39/14; B01D 46/0032; B01D 46/0036; B01D 2239/0407; B01D 2239/0435; B01D 2279/50

(57) ABSTRACT

A modular open-cell truncated polyhedral lattice system configured for geometry-driven phase interception is disclosed. The lattice introduces capillary discontinuities and pressure-gradient-modified pathways to control moisture, vapor, and fluid transport. Functional inserts may modify resistance, surface energy, particulate aggregation, or sorbent integration. Applications include foundation moisture mitigation, HVAC condensation management, and thermal break systems. Phase redistribution is achieved without molecular dissociation or chemical reaction.

### BACKGROUND OF THE INVENTION

Moisture intrusion beneath foundations leads to structural degradation, mold growth, and long-term material failure. Existing barriers rely on passive membranes or drainage layers lacking adaptive vapor regulation.

### SUMMARY OF THE INVENTION

The VaporWeave system introduces a structured lattice incorporating phase-intercept geometries that regulate vapor pressure and moisture flux beneath foundations, improving durability and environmental resilience.

### BRIEF DESCRIPTION OF THE DRAWINGS

FIG. 1 is a perspective view of a representative lattice module.

FIG. 2 is an enlarged schematic view of a representative lattice cell and junction region showing a representative vapor pathway and capillary interruption zone.

FIG. 3 is a sectional view showing a lattice layer disposed beneath a structural foundation.

FIG. 4 is an enlarged schematic view showing representative inserts within lattice cells, including a flow-resistance insert 60, a sorbent insert 62, and an electrostatic insert 64.

### DETAILED DESCRIPTION OF THE INVENTION

The system comprises modular lattice panels formed from polymeric or composite materials arranged in truncated-octahedral or equivalent geometries. Vapor is redirected through micro-channels that induce non-equilibrium phase transitions.

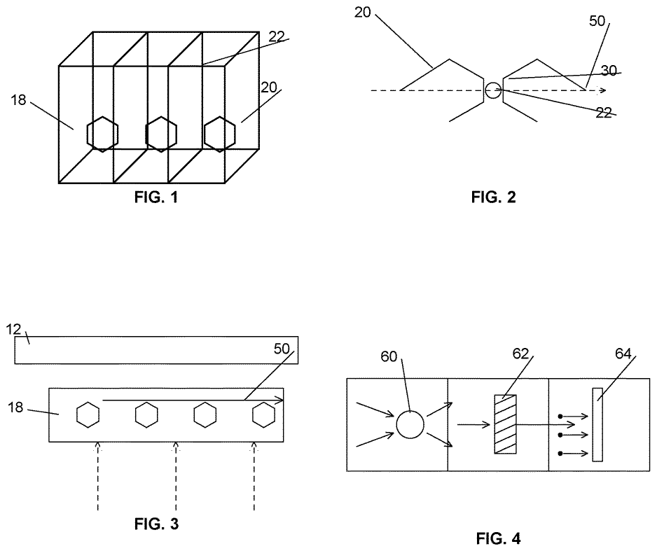

As shown in FIGS. 1-4, the lattice 18 may include cell wall members 20 meeting at junction nodes 22 to create a capillary interruption zone 30 and a representative vapor pathway 50, and optional inserts including a flow-resistance insert 60, a sorbent insert 62, and an electrostatic insert 64.

### INDUSTRIAL APPLICABILITY

Applicable to residential, commercial, and industrial construction for moisture mitigation and foundation longevity.

1. A phase-intercept lattice system comprising a three-dimensional open-cell lattice architecture formed from interconnected lattice cells and configured to create capillary discontinuities and modify vapor transport pathways through geometric junction transitions.

2. The system of claim 1 wherein the open-cell lattice architecture comprises repeating truncated octahedral cells, truncated polyhedral cells, modified polyhedral cells, cellular lattice cells, or other geometrically varied open-cell lattice cells.

3. The system of claim 1 wherein junction angles range between approximately 90 degrees and 135 degrees.

4. The system of claim 1 wherein cell dimensions range from approximately 5 millimeters to 150 millimeters.

5. The system of claim 1 further comprising one or more functional inserts positioned within lattice cells or at junction nodes.

6. The system of claim 5 wherein the inserts increase localized flow resistance.

7. The system of claim 5 wherein the inserts modify surface energy characteristics.

8. The system of claim 5 wherein the inserts comprise sorbent-carrying media.

9. The system of claim 5 wherein the inserts comprise electrostatic particle aggregation modules.

10. The system of claim 1 configured as a sub-foundation moisture mitigation layer.

11. The system of claim 1 configured within an HVAC airflow pathway.

12. The system of claim 1 wherein the lattice is oriented relative to gravity or pressure differential to bias vapor transport.

13. A method of controlling phase migration comprising positioning a three-dimensional open-cell lattice architecture within a vapor pathway such that capillary continuity is reduced by geometric junction transitions.

14. The method of claim 13 wherein vapor redistribution occurs without chemical reaction.

15. A modular interconnectable panel incorporating the lattice system of claim 1.
